(19) United States
(12) Patent Application Publication
(10) Pub. No.: US 2026/0276089 A1
(43) Pub. Date: Sep. 17, 2026

(54) DOSING VALVE

(71) Applicant: BUERKERT WERKE GMBH & CO. KG, Ingelfingen (DE)

(72) Inventors: Johannes BAUMANN, Ingelfingen (DE); Denis MAIER, Ingelfingen (DE); Florian FISCHER, Ingelfingen (DE); Ralf EGNER, Ingelfingen (DE)

(21) Appl. No.: 19/566,383

(22) Filed: Mar. 13, 2026

(30) Foreign Application Priority Data
Mar. 14, 2025 (DE) 102025109989.8

(51) Int. Cl. F16K 7/16; F16K 31/08; F16K 31/10

(52) U.S. Cl. CPC F16K 7/16; F16K 31/082; F16K 31/10

(57) ABSTRACT

A dosing valve comprises a valve body having an inlet opening and an outlet opening which extend from a common overflow chamber. This overflow chamber is delimited on one side by the valve body and on the other side by the diaphragm. The diaphragm has a coupling area at the rear, with which it is fastened to an actuating lever. A retaining part clamps the diaphragm between itself and the valve body at the edge. When the valve is opened, the diaphragm is tilted by the actuating lever and then rests on a rotationally asymmetrical supporting surface on the retaining part in the open position.

### TECHNICAL FIELD

The disclosure relates to a dosing valve comprising a valve body.

### BACKGROUND

In dosing valves having diaphragms, there are various ways of moving them between the open and the closed position. On the one hand, it is possible to raise and lower the diaphragm using a linearly movable armature, on the other hand, there are dosing valves having a pivotable actuating lever which is fastened to the diaphragm and can be pivoted about a pivot axis via a drive which is usually electromagnetic.

In so-called rocker valves, in which different openings can be closed alternately by the diaphragm, pressure equalization may occur in the diaphragm, which relieves the diaphragm. In the case of an actuating lever that engages the diaphragm at only one point, and in the case of a dosing valve in which the diaphragm, as in the present disclosure, continuously seals the overflow chamber against a rear chamber which does not allow pressure equalization, the diaphragm is stretched away from the valve body by the pressure of the fluid present in the overflow chamber. This is also referred to as “bulging” of the diaphragm. This leads to stress on the diaphragm. In addition, the expansion of the diaphragm enlarges the overflow chamber, so that more fluid volume must be displaced when closing. Furthermore, the volume of the overflow chamber is not constant due to the expansion of the diaphragm, as the diaphragm expands more at higher fluid pressure than at low fluid pressure, so that the volume of the overflow chamber is not constant, either. Finally, the closing force is also high, as the drive must exert a force which is greater than the opening force generated by the fluid pressure across the entire diaphragm surface.

To reduce or even completely avoid these disadvantages, a so-called supporting surface is provided on a retaining part which clamps the diaphragm between itself and the valve body. This retaining part is structurally pulled far inwards on the inside of the edge and at the same time closer to the diaphragm, so that in the open position, the diaphragm partially rests on the supporting surface at the rear. This prevents the diaphragm from expanding significantly and allows the volume of the overflow chamber to remain constant. The closing force required is also reduced.

The object of the disclosure is to further relieve the diaphragm and increase the long-term stability thereof.

### SUMMARY

The disclosure proposes a dosing valve comprising a valve body having an inlet opening and an outlet opening which extend from a common overflow chamber, a diaphragm which, together with the valve body, delimits the overflow chamber and is movable between an open and a closed position, wherein, in the closed position, the diaphragm rests on at least one valve seat in the overflow chamber and prevents flow from the inlet opening to the outlet opening, wherein a drive for the diaphragm is connected thereto at the rear at a coupling area via an actuating lever, and the actuating lever pivots between the open and the closed position about a pivot axis, moves the coupling area along an arc, and tilts the diaphragm, wherein the diaphragm includes an edge having a circumferential bead which projects towards the valve body and delimits the overflow chamber laterally, and the edge is clamped axially between the valve body and a retaining part, wherein the retaining part extends at the rear beyond the edge inwardly towards the coupling area and forms a supporting surface for the diaphragm in the open position, which runs rotationally asymmetrically around the coupling area, and an area of the supporting surface closest to the pivot axis runs obliquely inwards towards the coupling area to a plane defined by the valve seat, and the area of the supporting surface furthest away from the pivot axis maintains a greater distance from the plane towards the coupling area, and wherein the supporting surface is designed and positioned such that the diaphragm rests thereon along a closed circumferential ring surface in the open position when the dosing valve is unpressurized.

Whereas in previous valves the supporting surface was always formed to be rotationally symmetrical, namely around the usually central coupling area, the supporting surface in the disclosure is adapted to the natural deformation of the diaphragm due to the tilting movement. The coupling area is rather rigid because the diaphragm is usually thickened at the rear to be coupled to the actuating lever. This results in a ring area around this coupling area up to the clamped edge of the diaphragm, which allows the tilting movement. This ring area undergoes deformation due to the tilting movement, which leads to a rotationally asymmetrical geometry of this ring area. Thus, viewed in cross-section, the area furthest away from the pivot axis, as seen from the edge, tilts further upward from the plane of the valve seat than the nearest area. The intermediate areas, i.e., the areas between the nearest and the furthest area, then have to cover continuously increasing distances upon tilting, the closer they are to the furthest area of the supporting surface. Since the supporting surface thus hinders the “natural” movement and natural geometric change of the different areas of the diaphragm less or not at all, it is subjected to less stress.

In addition, the ring surface, i.e., the contact surface between the diaphragm and the supporting surface, is thus automatically larger than with rotationally symmetrical supporting surfaces, which in turn improves the constancy of the volume of the overflow chamber and reduces the opening pressure to be applied.

Situations such as those in the prior art, in which no closed circumferential ring surface contacts the supporting surface, may therefore no longer occur.

The larger area with which the diaphragm rests on the supporting surface reduces the closing force required for closing.

According to one variant of the disclosure, the supporting surface has a geometry complementary to the rear side of the diaphragm, which the diaphragm has in the open position when the dosing valve is unpressurized. The deformed geometry of the diaphragm in the open position without contact with a supporting surface, but of course clamped at the edge, is thus determined. The ring surface on the rear side of the diaphragm is used as a reference surface for the supporting surface. This in turn means that if, in the open position, the pressure from the pressure fluid is then also applied to the diaphragm, it does not first have to expand slightly to make contact with the supporting surface, because at this point there is already a closed circumferential ring surface as contact between the diaphragm and the supporting surface.

To keep the area of the diaphragm which does not come into contact with the supporting surface as small as possible, i.e., the area between the clamped edge and the coupling area, at least 60% of this part of the rear side of the diaphragm should contact the supporting surface.

For example, the diaphragm is not a disc of uniform thickness, but has a one-piece retaining extension on the rear side in the coupling area, which projects therefrom and also defines and forms the coupling area.

The diaphragm is a replaceable part and can be fastened to the actuating lever in a non-destructively detachable manner, for example by form fit.

For this purpose, a mushroom-like fastening projection may protrude from the actuating lever. The diaphragm has a complementary receptacle in the retaining extension, which accommodates the fastening projection. This creates a kind of latching connection. Of course, conversely, a fastening projection having a groove provided on the circumference may also be provided on the actuating lever, which then accommodates the complementarily formed retaining extension on the diaphragm.

When referring to a fastening projection on the actuating lever, this includes both a projection which is formed integrally on the actuating lever and forms the fastening projection, and a separate part attached to the actuating lever and having this fastening projection.

The diaphragm may have a sleeve-like extension, which forms the complementary receptacle.

Optionally, a securing sleeve may also be provided, which radially supports the diaphragm outwards in the area of the axial end of the sleeve-like extension so that this sleeve-like extension cannot expand so far that the diaphragm detaches from the retaining extension.

Either the valve seat of the inlet opening or of the outlet opening may be aligned centrically with the diaphragm so that in the closed position, the diaphragm has a central section resting on the valve seat.

The coupling area is for example centered with respect to the central section, so that the force applied across the coupling area is directed directly towards or away from the valve seat and the diaphragm therefore does not have to compensate for any additional deformation between the applied force and the valve seat.

According to one variant, the diaphragm is circular in a top view, which, on the one hand, facilitates the manufacture thereof and, on the other hand, makes deformation during the tilting movement easier and simplifies the manufacture of the valve body and the retaining part.

In the case of a circular diaphragm, the diaphragm may have a disc-shaped section and two axially protruding beads surrounding the disc-shaped section on the frame side. One bead faces the valve seat, more precisely, the side of the diaphragm associated with the valve seat, and one bead is provided on the side facing away from the valve seat and protrudes axially here. This bead facing away from the valve seat is accommodated in a ring groove in the retaining part, in which it is axially loaded by the retaining part. The diaphragm is thus held and tensioned at the edge by an axial force in the area of the beads, so that the bead facing radially towards the valve seat can also form the side surface of the overflow chamber and seals against the valve body. The diaphragm is also radially preloaded. The diaphragm is approx. 0.1 mm larger in diameter than the receptacle in the retaining part. The radial preload increases movability, and the axial support prevents bulging, as the radial preload further promotes bulging.

Even in the closed position of the valve, there is a smaller area of the supporting surface which rests on the diaphragm at the rear, wherein this area also touches a closed ring surface at the rear of the diaphragm which is adjacent to the ring groove. This area stabilizes the position of the diaphragm and the disc-shaped section.

The actuating lever is, for example, a single-arm actuating lever mounted pivotably on the valve body or the retaining part via a bearing pin and is therefore not a rocker-type tilting lever.

An electromagnetic drive, which drives the actuating lever and can optionally move to positionally stable positions between the open and the closed position, is provided as a drive.

Here, a Lorentz force drive, which has a compact design, has proven to be a particularly advantageous drive.

This Lorenz force drive has an air coil mounted on the actuating lever and at least one stationarily mounted permanent magnet to which the air coil is adjacent. When the air coil is energized, the air coil is moved relative to the permanent magnet and thus pivots the actuating lever.

The actuating lever may be spring-loaded into a pivoting position, e.g., into the closed position of the valve, to create a normally closed valve.

In contrast to miniature pumps, in which the diaphragm opens and closes several inlet or outlet openings laterally in succession, the dosing valve of the disclosure is a 2/2-way valve and the diaphragm can therefore only close the inlet opening or the outlet opening, whereas the other of the two openings is always open.

To enable the dosing valve to be designed as compactly as possible and to position the plane of the valve seat so that the pivot axis also lies in this plane or the pivot axis is close to this plane, the actuating lever has two L-shaped legs aligned with each other. The bearing pin, i.e., the pivot bearing, is located at one axial end of a leg, and the diaphragm is located in the space enclosed by the two legs, which allows it to move close to the valve seat.

For fast opening and closing movements and also to ensure that the volume of the overflow chamber remains as constant as possible regardless of the pressure of the pressure fluid, a rigid diaphragm is better, as has been found. Therefore, the disclosure provides that according to one variant of the disclosure, the diaphragm has an outer diameter which is in the range of 5 to 9 times the inner diameter of the inlet opening or outlet opening enclosed by the valve seat, depending on which of these two openings has the valve seat.

In addition or alternatively, the thickness of the diaphragm at the thinnest point thereof may be between 0.2 and 0.8 times the inner diameter of the inlet opening or the outlet opening enclosed by the valve seat. This results in a diaphragm which is small in its outer dimensions and relatively thick, thus improving the reproducibility of identical strokes.

A further disclosure, which is independent of the above disclosure but can also be combined therewith, provides various embodiments. These embodiments also aim to keep the overflow chamber as small as possible and to optimize the flushing of the overflow chamber. This is achieved in that a base surface of the valve body, which also delimits the overflow chamber, has a C-shaped recess in a top view, which extends around the annular projection protruding from the base surface and defining the valve seat. The recess thus nestles around the extension so that the width of the recess can be kept small, which in turn minimizes the width of the overflow chamber (in the case of annular diaphragms, the diameter of the overflow chamber). The C-shaped recess thus represents a partially annular, relatively large mouth area for the opening extending therefrom. For example, the opening extending from the C-shaped recess tapers in sections in a funnel shape into the valve body, which improves the flow guidance and also enables better flushability as the area of the C-shaped recess can be kept larger than the cross-sectional area of the opening spaced from the base area.

### Embodiments:

Embodiment 1: A dosing valve, comprising a valve body having two openings in the form of an inlet opening and an outlet opening, which extend from a common overflow chamber in the valve body, a diaphragm which, together with the valve body, delimits the overflow chamber and is movable between an open and a closed position, wherein a base surface of the valve body delimits the overflow chamber and an annular extension surrounding one of the two openings projects from the base surface into the overflow chamber and the upper side of the extension forms a valve seat in the overflow chamber, on which the diaphragm rests in a sealing manner in the closed position and prevents flow from the inlet opening to the outlet opening, wherein, laterally adjacent to the extension, the base surface has a C-shaped recess which forms the mouth of the other of the two openings on the base surface, wherein the recess extends in sections around the extension and surrounds the latter in sections.

Embodiment 2: The dosing valve according to embodiment 1, wherein the diaphragm is circular disc-shaped and the center of the diaphragm is aligned with the valve seat.

Embodiment 3: The dosing valve according to embodiment 2, wherein the C-shaped recess has a radially outer, circular segment-shaped edge which is adapted to the curvature of the edge of the diaphragm and/or has a radially inner, circular segment-shaped edge which adjoins the extension and extends along the extension.

Embodiment 4: The dosing valve according to any of the preceding embodiments, wherein the diaphragm has a circular disc-shaped section which delimits the overflow chamber opposite the base surface, and has a bead which surrounds the circular disc-shaped section on the frame side and projects axially to the base surface and delimits the overflow chamber laterally, for example wherein the bead is designed without undercuts.

Embodiment 5: The dosing valve according to embodiments 3 and 4, wherein the radially outer, circular segment-shaped edge of the C-shaped recess adjoins the bead.

Embodiment 6: The dosing valve according to any of the preceding embodiments, wherein the cross-sectional area of the opening surrounded by the valve seat at the mouth of the valve seat is smaller than the cross-sectional area of the C-shaped recess at the base surface.

Embodiment 7: The dosing valve according to any of the preceding embodiments, wherein the base surface is flat.

Embodiment 8: The dosing valve according to any of the preceding embodiments, wherein the opening extending from the C-shaped recess tapers in sections in a funnel shape.

Embodiment 9: The dosing valve according to any of the preceding embodiments, wherein the opening extending from the C-shaped recess ends on the outer side of the valve body opposite the base surface and the opening extends obliquely away from the opening leading into the valve seat towards this outer side.

Embodiment 10: The dosing valve according to embodiment 9, wherein the direction in which the opening runs obliquely in the area of the opening to the outer side opposite the base surface has a directional component perpendicular to the outer side and a directional component on the outer side, and the opening extending from the C-shaped recess has an oval cross-section in a section starting from the outer side, viewed in the direction (X in FIG. 9) of the central axis of this section of the opening, with the greatest width of the oval in a direction perpendicular to a plane in which, on the one hand, the central axis and, on the other hand, the directional component on the outer side lie.

Embodiment 11: The dosing valve according to embodiment 10, wherein the mouth of the opening extending from the C-shaped recess is circular on the outer side.

Embodiment 12: The dosing valve according to any of the preceding embodiments, wherein the valve body has a recess on the outer side opposite the base surface, into which both openings lead and into which a plate-shaped, elastomeric sealing part having holes is inserted which are aligned with the respective openings and seal the two openings with respect to each other.

Embodiment 13: The dosing valve according to any of the preceding embodiments, wherein the diaphragm has an outer diameter which is in the range of 5 to 9 times the inner diameter of the inlet opening or the outlet opening enclosed by the valve seat and/or the thickness of the diaphragm at the thinnest point thereof is between 0.2 and 0.8 times the inner diameter of the inlet opening or the outlet opening enclosed by the valve seat.

Embodiment 14: The dosing valve according to any of the preceding embodiments, wherein the opening surrounded by the valve seat is the inlet opening.

Embodiment 15: according to any of the preceding embodiments, wherein it is a 2/2-way valve and the diaphragm can close only the inlet opening or the outlet opening, and the other opening being always open.

Embodiment 16: The dosing valve according to any of the preceding embodiments, wherein the diaphragm is a one-piece, materially homogeneous part.

Embodiment 17: The dosing valve according to any of the preceding embodiments, wherein in the open position, the diaphragm presses against an end stop at the rear.

Embodiment 18: The dosing valve according to any of the preceding embodiments, wherein an electromagnetic drive is provided which drives an actuating lever coupled to the diaphragm and which can move to positionally stable intermediate positions between the open and the closed position.

Embodiment 19: The dosing valve according to embodiment 18, wherein the drive is a Lorentz force drive having an air coil mounted on the actuating lever, and at least one stationarily mounted permanent magnet is adjacent to the air coil, wherein the air coil moves relative to the permanent magnet when the air coil is energized and pivots the actuating lever.

Embodiment 20: The dosing valve according to embodiment 8 or 19, wherein the actuating lever is spring-loaded into a pivoting position.

### BRIEF DESCRIPTION OF THE DRAWINGS

Further features and advantages of the disclosure will become apparent from the following description and the following drawings, to which reference is made and in which:

FIG. 1 shows a view of the dosing valve according to the disclosure without the outer housing and some other parts, to explain the valve body and the drive,

FIG. 2 shows a sectional view through the dosing valve according to FIG. 1 in the area of the valve body,

FIG. 3 shows a detailed sectional view through the dosing valve according to FIG. 1 with part of the actuating lever and the diaphragm in the closed state,

FIG. 4 shows a corresponding view of the detail according to FIG. 4 with the valve open and no pressure in the overflow chamber,

FIG. 5 shows a corresponding view of the detail according to FIG. 4 with the valve open and pressure in the overflow chamber,

FIG. 6 shows a detailed sectional view showing a different connection of the diaphragm to the actuating lever,

FIG. 7 shows a detailed sectional view with a further option for connecting the diaphragm to the actuating lever,

FIG. 8 shows a top view of the valve body in the dosing valve according to the disclosure, and

FIG. 9 shows a sectional view through the valve body according to FIG. 8.

### DETAILED DESCRIPTION

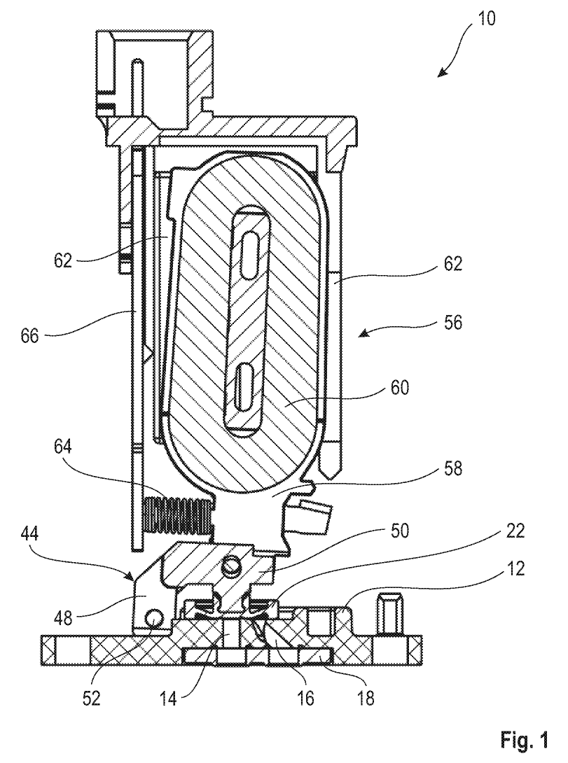

FIG. 1 shows a dosing valve 10 having a plate-like valve body 12, by means of which the dosing valve 10 can be flanged to an adjacent fluid-carrying part.

The valve body has an inlet opening 14 extending from its lower side and an outlet opening 16.

The lower side of the valve body 12 has a recess into which an elastomeric part 18 is inserted, which has openings representing extensions of the inlet opening 14 and the outlet opening 16. At the lower end of the elastomeric part 18, each of these openings is surrounded by a ring bead which protrudes downwards relative to the lower side of the valve body 12. This serves to seal against the adjacent part onto which the valve body 12 is screwed.

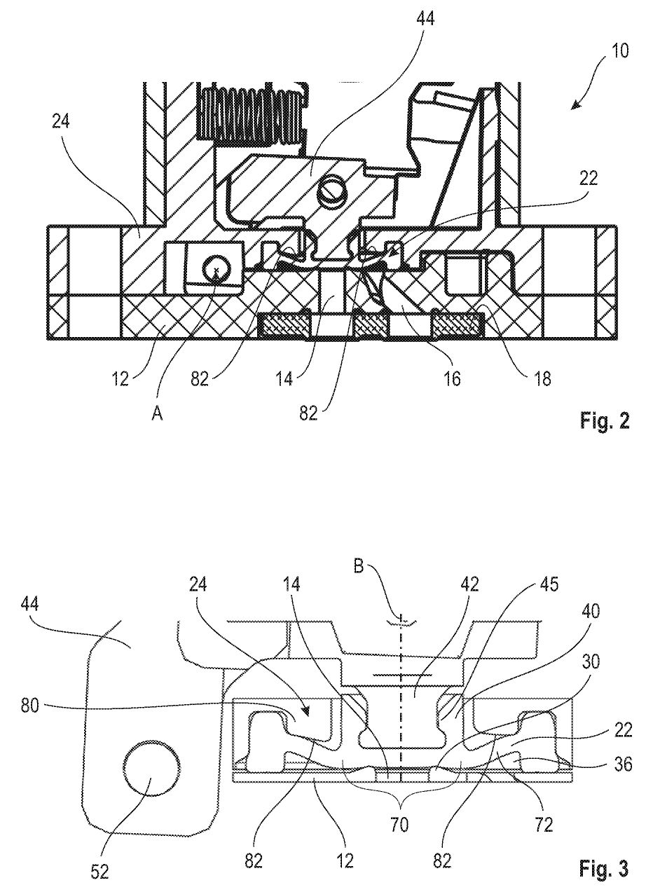

FIG. 2 shows that an elastomeric diaphragm 22 is provided on the upper side of the valve body 12, which is clamped between a retaining part 24 and the valve body 12. As can be seen more clearly in FIGS. 3 to 5, the clamping takes place in the area of two beads 26, 28 which protrude in opposite directions, are molded onto the diaphragm 22, and run completely around the edge thereof.

The annular bead 26 protrudes downwards, i.e., towards one side of the valve body 12, which is also referred to as the side with a valve seat 30.

The valve seat 30 is the upper end of an annular extension (ring extension) around the mouth of the inlet opening 14, which protrudes upwards with respect to a flat base surface 32 of the valve body 12 opposite the diaphragm 22.

The bead 28 runs in the opposite direction to the bead 26 and protrudes into a ring groove 34 in the retaining part 24.

Axial pressure is exerted via the retaining part 24 in the ring groove 34 on the two beads 26, 28 to clamp the diaphragm 22 at the edge. Furthermore, the diaphragm 22 is also clamped radially.

An overflow chamber 36 (see FIG. 3) is delimited between the upper side of the valve body 12 and the diaphragm 22, into which the inlet opening 14 and the outlet opening 16 lead. The overflow chamber 36 is defined laterally by the bead 26 and upwardly by a disc-shaped area of the diaphragm 22 adjoining the bead 26.

In this disc-shaped area of the diaphragm 22, a sleeve-shaped retaining extension 40 is integrally molded onto the rear side of the diaphragm, into which a mushroom-like fastening projection 42 on a single-arm actuating lever 44 latches. The retaining extension 40 has a shape and receptacle complementary to the mushroom-shaped fastening projection 42.

The diaphragm 22 is fastened to the actuating lever 44 in a non-destructively detachable manner via this latching connection. In other words, it can be defined that the fastening projection 42, which protrudes into the retaining extension 40, has a groove provided on the circumference (after the mushroom head), into which a complementary retaining extension on the diaphragm 22 protrudes. In this case, the retaining extension would be an annular bead 45 protruding radially inwards from the sleeve-shaped retaining extension 40.

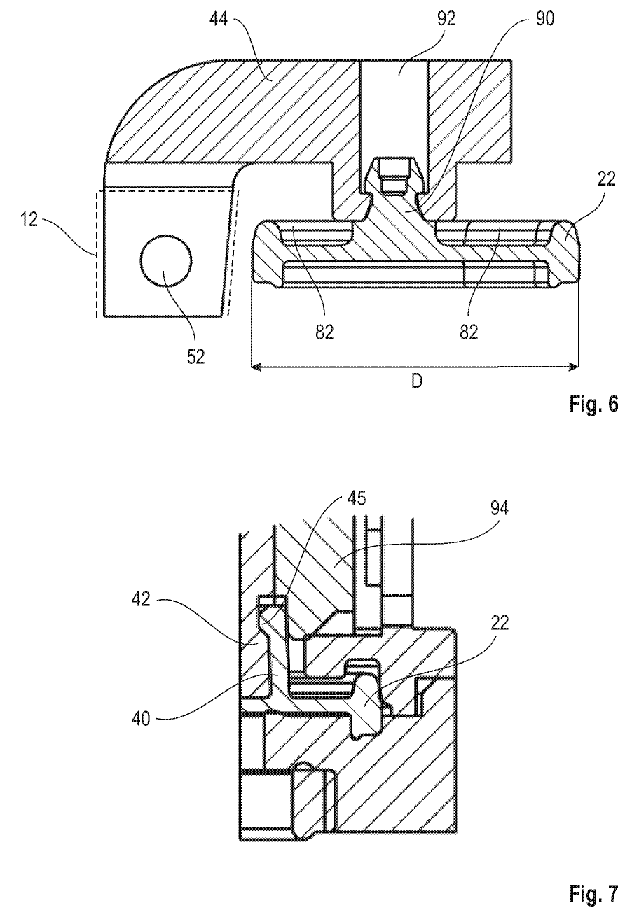

The actuating lever 44, which is shown in FIGS. 1 and 2, is a single-arm lever having two legs 48, 50, wherein a bearing pin 52 is provided at the lower end of the leg 48 and constitutes a pivot bearing for the actuating lever 44 and is received in the retaining part 24 or in the valve body 12 (see broken lines in FIG. 6).

The two legs 48, 50 are aligned with each other in an L-shape, wherein the fastening projection 42 protrudes downwards from the leg 50, which may be integrally formed thereon or may form a separate part.

The diaphragm 22 is accommodated in the space delimited by the two legs 48, 50. This allows the diaphragm 22 to lie at the level of the bearing pin 52, as can be seen in FIG. 2. The central axis A of the bearing pin 52, which forms the imaginary axis of rotation, lies in a plane E defined by the valve seat 30 (see FIG. 5).

To pivot the actuating lever 44, an electromagnetic drive in the form of a Lorentz force drive 56 is provided, which can optionally move to positionally stable intermediate positions between the open and the closed position.

The Lorentz force drive 56 comprises a plate-shaped coil carrier 58 made of non-magnetizable material such as plastic, which is fastened to the leg 50 and carries a so-called air coil 60. Permanent magnets 62 are firmly connected to a housing at a short distance from the air coil 60 on the frame side, the housing being omitted here.

When the air coil 60 is energized, it is moved by the permanent magnets 62, causing the actuating lever 44 to pivot.

A return spring 64 tends to move the dosing valve to the closed position and for this purpose is preloaded between a housing-fixed part 66 and the coil carrier 58.

In a top view, the diaphragm 22 is for example circular, wherein this is optionally the case.

The retaining extension 40 forms a coupling area and, in this embodiment, defines a so-called central section 70 of the diaphragm 22 (see the area enclosed in brackets in FIG. 3), in which the diaphragm 22 is stiffer.

The central section 70 coincides here with the coupling area as the central section 70 is here precisely aligned with the area of the diaphragm 22 which is responsible for fastening to the actuating lever 44, i.e., the retaining extension 40.

The central section 70 with the retaining extension 40 and the received fastening projection 42 is, relative to the closed position of the dosing valve 10 shown in FIG. 3, exactly centered with respect to the inlet opening 14, which is symbolized by the axis B.

A circumferential ring section 72 of the diaphragm 22, which is designed to be thin, is located between the central section 70 and the beads 26, 28. This is where the diaphragm 22 has the greatest flexibility.

In the position shown in FIG. 3, the diaphragm 22 is seated with its lower side on the valve seat 30 and seals here. The force applied by the actuating lever 44 and the fastening projection 42 thereof is applied directly to the valve seat 30.

FIGS. 3 to 5 clearly show that on the rear side of the diaphragm 22 in the area of the ring section 72, i.e., adjacent to the groove 34, the retaining part 24 has a circumferential extension 80, the side of which facing the ring section 72 forms a so-called supporting surface 82 for the diaphragm 22 in the area of the ring section 72.

This supporting surface 82 is specially shaped. The radially outermost section of the supporting surface 82 immediately adjacent to the groove 34 permanently rests on this area of the ring section 72 to hold the diaphragm 22 laterally, more precisely, to position the bead 28 laterally.

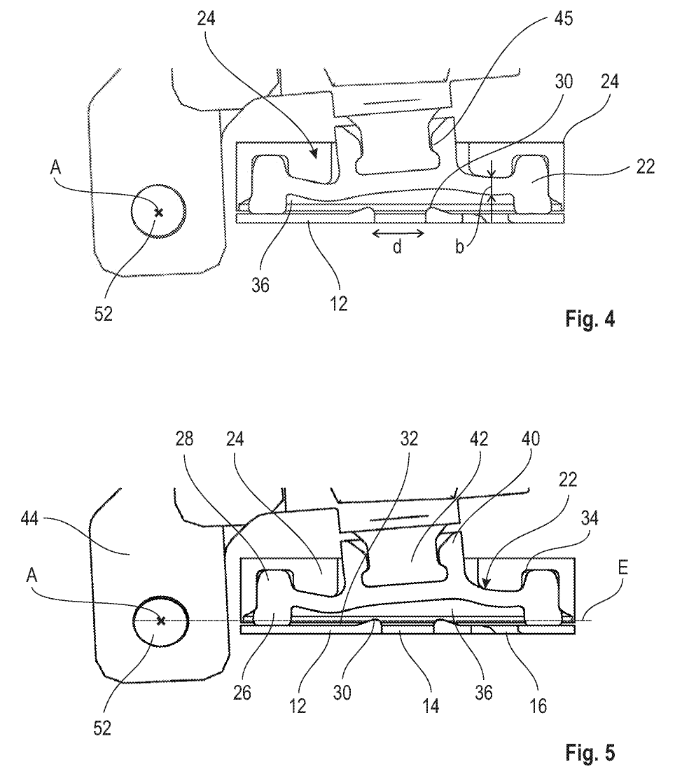

The position and orientation of the supporting surface 82 is adapted to the natural deformation of the diaphragm 22, for example the ring section 72 thereof in the open position (see FIGS. 4 and 5), when no fluid pressure is applied thereto.

As can be seen from the comparison between the positions of the retaining extension 40 and the diaphragm 22 in FIGS. 3 and 4, the diaphragm 22 is not only lifted in the area of the central section 70 by pivoting the actuating lever 44, but also tilted slightly due to the pivoting movement. This means that the lower side of the diaphragm 22 is asymmetrical in the open state, as further away from the bearing pin 52, the lower side is further away from the valve body 12 than the areas of the ring section 72 near the bearing pin 52.

The supporting surface 82 is therefore rotationally asymmetrical.

The area of the supporting surface 82 closest to the pivot axis A, here the bearing pin 52 (in FIG. 3, the area of the supporting surface 82 to the left of the central section 70), runs towards the coupling area, i.e., towards the axis B, obliquely to the plane E defined by the valve seat, i.e., generally obliquely downwards and radially inwards, relative to FIG. 3.

If the ring section 72 were rotationally symmetrical, the area furthest away from the pivot axis A, i.e. in FIG. 3 the right-hand section of the supporting surface 82, would be just as far from the plane E as the left-hand area. However, FIGS. 3 to 5 show that this more distant area of the supporting surface 82 maintains a greater distance from the aforementioned plane E towards the coupling area (i.e., in the direction of axis B) than the left-hand area of the supporting surface 82.

The supporting surface 82 therefore runs such that, when the dosing valve is unpressurized (FIG. 4), the diaphragm 22 rests thereon in the area of the ring section 72 along a closed circumferential ring surface. The diaphragm 22 is thus supported over almost the maximum possible area in the region of the ring section 72.

For example, the supporting surface 82 is even designed so as to have a geometry complementary to the rear side of the diaphragm 22 in the ring section 72, namely the geometry that the ring section 72 has on the rear side in the open position of the dosing valve 10 and when the valve is simultaneously unpressurized.

When pressure is then exerted on the diaphragm 22 by a pressure fluid entering the overflow chamber 36, the diaphragm 22 can only move minimally compared to the position in FIG. 4, so that the volume of the overflow chamber 36 remains almost unchanged. The position of the diaphragm 22 can also be precisely predetermined and is always the same due to the large-area contact with the supporting surface 82, as is the movement stroke of the actuating lever 44.

Due to the rotatability of the actuating lever 44, the coupling area moves along an arc, or more precisely, a circular arc. The supporting surface 82 can be designed so as to contact at least 60% of the ring section 72, i.e., the area between the edge represented by the bead 28 and the coupling area defined by the retaining extension 40 sleeve-shaped here.

In the embodiment according to FIG. 6, it can be seen that the diaphragm here has a retaining extension 90 protruding from the rear in the form of a mushroom head, which engages into an opening 92 in the actuating lever 44.

As the opening 92 has an undercut, the mushroom head can engage in this undercut.

FIG. 6 also shows that the retaining extension 90 is slightly offset to the side of the otherwise circular diaphragm 22. However, the retaining extension 90 remains precisely aligned with the valve seat 30 in relation to the closed position of the dosing valve 10 and is centered exactly thereabove. Here too, as can be clearly seen, the supporting surface 82 is designed to be rotationally asymmetrical and has a greater distance in the areas further away from the bearing pin 52 than in the nearby areas, wherein the corresponding sections in the more distant areas do not protrude radially inwards and at the same time towards the valve body 12 or are less strongly inclined obliquely downwards than in the nearby areas (left-hand area of the supporting surface 82 in FIG. 6).

FIG. 7 shows a further variant of how the diaphragm 22 can be locked at the rear on the fastening projection 42, namely in that a retaining sleeve 94 on the outer side surrounds the free end of the sleeve-shaped retaining extension 40, so that the bead 45 at this end at the sleeve-shaped retaining extension 40, which engages in a corresponding groove in the fastening projection 42, cannot slip out of this groove.

However, the supporting surface 82 is designed such that even in the closed valve position (see FIG. 3), the diaphragm 22 rests on the supporting surface 82 via a ring surface (ring-shaped contact surface) defined on the upper side of the ring section 72 and directly adjacent to the ring groove 34. This section of the supporting surface 82, which begins radially on the outer side, thus always rests on the ring section 72 (see FIGS. 3 to 5).

The valve shown is a 2/2-way valve in which the inlet opening can be selectively opened and closed, but the outlet opening 16 is permanently open. Of course, the openings 14, 16 could also be reversed, i.e., the central opening is then the outlet opening 16 and the off-center opening is the inlet opening 14.

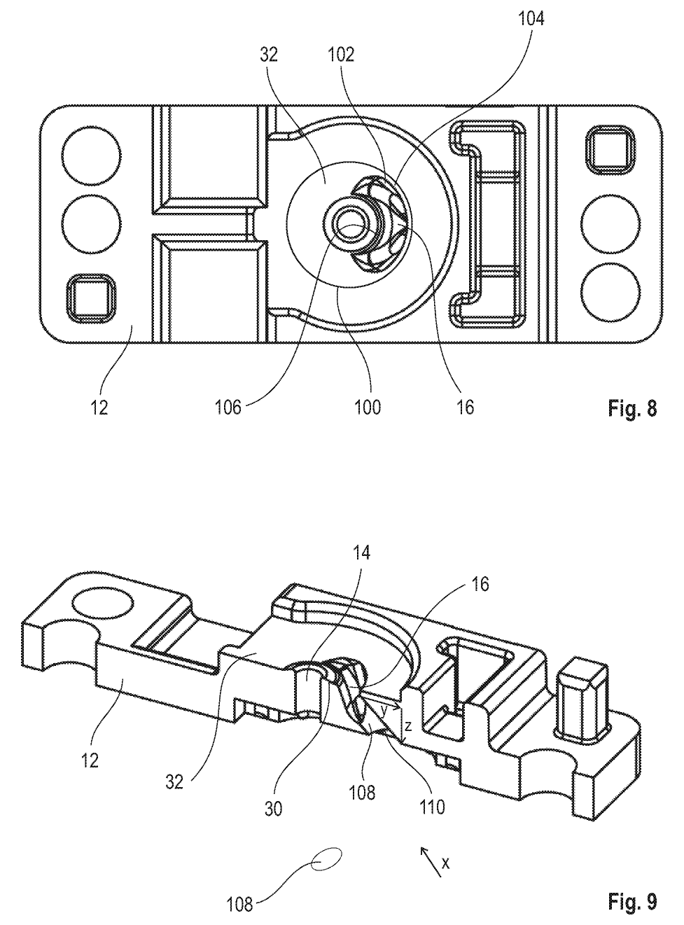

FIGS. 8 and 9 show a special feature which, taken alone, represents a separate inventive idea and does not necessarily have to be combined with the aforementioned idea for a specially designed supporting surface for the diaphragm.

FIGS. 8 and 9 clearly show the aforementioned flat base surface 32, from which the valve seat 30, formed by the upper end of the ring extension, protrudes upwards. The circle 100 shown in FIG. 8 denotes the radially innermost section of the bead 26, i.e., the radially outermost area of the overflow chamber.

At the base surface 32, the outlet opening 16 has a C-shaped mouth, the mouth extending around the ring extension and surrounding the latter in sections. At the radially outer edge 104, the C-shaped recess 102 has a shape which is adapted to the circle 100 and runs only at a minimal distance therefrom, so that the width of the overflow chamber 36 is utilized to give the recess 102 the maximum width.

This outer edge 104 of the recess 102 is therefore circular segment-shaped and adapted to the curvature of the edge of the diaphragm 22. As mentioned above, the radially inner, circular segment-shaped edge 106 of the recess 102 is adapted to the ring extension and adjacent thereto.

To enable optimum and rapid flushing of the overflow chamber 36, the cross-sectional area of the recess 102 at the level of the base surface is even larger than the cross-sectional area of the opening surrounded the valve seat 30 (here the outlet opening 16) at the mouth thereof.

For optimum flow, the opening (here the outlet opening 16) tapers from the C-shaped taper over a section of the thickness of the valve body 12, as can be seen in FIG. 9.

The funnel-shaped section extends approximately over at least 30% of the thickness of the valve body 12 in this area. This ensures that the taper is not too abrupt to optimize the flow. At the end of the taper, there is a section 108 of the opening 16 extending obliquely away from the inlet opening 14 to the lower side of the valve body 12.

The mouth 110 of the opening 16 towards the lower side is circular when viewed from below. However, this means that the section 108 of the inlet opening 14 must be oval as seen in the direction of the longitudinal extension of the section 108, i.e., in the direction of the arrow X in FIG. 9, to compensate for the slope of the section 108 towards the lower side and to achieve a circular cross-section of the mouth at the lower side.

Viewed in the direction of the arrow X in FIG. 9, the opening 16 in the section 108 to the left of the arrow X is shown separately to illustrate the oval shape.

The greatest width of the oval runs in the direction perpendicular to a plane (here perpendicular to the sectional plane, i.e., the drawing plane in FIG. 9) in which, on the one hand, the central axis of the outlet opening 16 in the section 108 and, on the other hand, a directional component on the outer side lie, as will be explained below: In the section 108, the opening 16 has, due to its oblique orientation, two vectors determining this orientation, namely a directional component Y on the outer side (here the lower side) of the valve body 12, so to speak, and a directional component Z perpendicular to the outer side or lower side.

The greatest width of the oval results in a direction perpendicular to a plane (here the sectional plane in FIG. 9) in which, on the one hand, the central axis of the opening in the section 108 and, on the other hand, the directional component Y lie. These two straight lines span the plane to which the greatest width of the oval is perpendicular.

The diaphragm 22 is, for example in all embodiments, but this is not to be understood as limiting, a one-piece, materially homogeneous part to simplify the manufacture thereof.

The diaphragm 22 is relatively small and thick, with an outer diameter D (see FIG. 6) which is in the range of 5 to 9 times the inner diameter d of the inlet opening 14 enclosed by the valve seat 30 (see FIG. 4).

Alternatively or additionally, the thickness b of the diaphragm 22 at the thinnest point thereof (see FIG. 4) can be between 0.2 and 0.8 times the inner diameter D.

1. A dosing valve, comprising a valve body having an inlet opening and an outlet opening which extend from a common overflow chamber, a diaphragm which, together with the valve body, delimits the overflow chamber and is movable between an open and a closed position, wherein, in the closed position, the diaphragm rests on at least one valve seat in the overflow chamber and prevents flow from the inlet opening to the outlet opening, wherein a drive for the diaphragm is connected thereto at the rear at a coupling area via an actuating lever, and the actuating lever pivots between the open and the closed position about a pivot axis, moves the coupling area along an arc, and tilts the diaphragm, wherein the diaphragm includes an edge having a circumferential bead which projects towards the valve body and delimits the overflow chamber laterally, and the edge is clamped axially between the valve body and a retaining part, wherein the retaining part extends at the rear beyond the edge inwardly towards the coupling area and forms a supporting surface for the diaphragm in the open position, which runs rotationally asymmetrically around the coupling area, and an area of the supporting surface closest to the pivot axis runs obliquely inwards towards the coupling area to a plane defined by the valve seat, and the area of the supporting surface furthest away from the pivot axis maintains a greater distance from the plane towards the coupling area, and wherein the supporting surface is designed and positioned such that the diaphragm rests thereon along a closed circumferential ring surface in the open position when the dosing valve is unpressurized.

2. The dosing valve according to claim 1, wherein the supporting surface has a geometry complementary to the rear side of the diaphragm which the diaphragm has in the open position when the dosing valve is unpressurized.

3. The dosing valve according to claim 1, wherein the supporting surface contacts at least 60% of that part of the rear side which lies between the edge and the coupling area.

4. The dosing valve according to claim 1, wherein a retaining extension protrudes integrally at the rear of the diaphragm and forms the coupling area on the diaphragm.

5. The dosing valve according to claim 1, wherein the diaphragm is fastened to the actuating lever in a non-destructively detachable manner.

6. The dosing valve according to claim 5, wherein a retaining extension protrudes integrally at the rear of the diaphragm and forms the coupling area on the diaphragm and wherein a mushroom-like fastening projection protrudes from the actuating lever and the diaphragm has a complementary receptacle in the retaining extension which receives the fastening projection, or a fastening projection is provided on the actuating lever, having a groove which is provided on the circumference and receives the complementary retaining extension on the diaphragm.

7. The dosing valve according to claim 6, wherein the fastening projection is a separate part attached to the actuating lever or an integrally molded projection.

8. The dosing valve according to claim 6, wherein the diaphragm has a sleeve-like retaining extension which forms the complementary receptacle.

9. The dosing valve according to claim 8, wherein a securing sleeve is provided which radially supports the diaphragm outwards in the region of the axial end of the sleeve-like extension.

10. The dosing valve according to claim 1, wherein either the valve seat of the inlet opening or of the outlet opening is aligned centrally with the diaphragm so that in the closed position, the diaphragm has a central section resting on the valve seat.

11. The dosing valve according to claim 10, wherein the coupling area is centered with respect to the central section.

12. The dosing valve according to claim 1, wherein in a top view, the diaphragm is circular.

13. The dosing valve according to claim 12, wherein the diaphragm has a disc-shaped section and two axially protruding beads (26, 28) surrounding the disc-shaped section on the frame side, wherein one bead is the bead facing the valve seat and one bead protrudes axially on the side facing away from the valve seat, wherein the bead facing away from the valve seat is received in a ring groove in the retaining part.

14. The dosing valve according to claim 13, wherein, in the closed position, the diaphragm rests on the supporting surface via a ring surface adjacent to the ring groove.

15. The dosing valve according to claim 1, wherein the actuating lever is a single-arm actuating lever pivotally mounted on the valve body or on the retaining part via a bearing pin.

16. The dosing valve according to claim 1, wherein an electromagnetic drive which drives the actuating lever is provided.

17. The dosing valve according to claim 1, wherein the drive is a Lorentz force drive.

18. The dosing valve according to claim 17, wherein the Lorentz force drive has an air coil mounted on the actuating lever and wherein at least one stationarily mounted permanent magnet is adjacent to the air coil, wherein the air coil moves relative to the permanent magnet when the air coil is energized and pivots the actuating lever.

19. The dosing valve according to claim 1, wherein the dosing valve is a 2/2-way valve and the diaphragm can only close the inlet opening or the outlet opening, the other opening being always open.

20. The dosing valve according to claim 1, wherein the diaphragm has an outer diameter which is in the range of 5 to 9 times the inner diameter of the inlet opening or the outlet opening enclosed by the valve seat, and/or the thickness of the diaphragm at the thinnest point thereof is between 0.2 and 0.8 times the inner diameter of the inlet opening or the outlet opening enclosed by the valve seat.
